(19) United States
(12) Patent Application Publication
(10) Pub. No.: US 2026/0370946 A1
(43) Pub. Date: Nov. 19, 2026

(54) OPTICAL ARCHITECTURE FOR AIRBORNE INFRARED WIDE AREA SEARCH

(71) Applicant: Raytheon Company, Arlington, VA (US)

(72) Inventors: David Christopher Mann, Frisco, TX (US); Thomas W. Ross, Celeste, TX (US); Jeff M. Gallagher, Anna, TX (US)

(21) Appl. No.: 19/211,010

(22) Filed: May 16, 2025

(51) Int. Cl. H04N 23/69; G02B 26/08; G02B 27/00; H04N 23/20; H04N 23/695

(52) U.S. Cl. CPC H04N 23/69; G02B 26/0816; G02B 27/0081; H04N 23/20; H04N 23/695

(57) ABSTRACT

An apparatus includes a dual head mirror pair configured to receive infrared radiation. The apparatus also includes a field of view (FOV) adjuster optically coupled to the dual head mirror pair and configured to change an effective focal length of the apparatus. The apparatus further includes a focal plane array (FPA) optically coupled to the dual head mirror pair and the FOV adjuster and configured to receive the infrared radiation. The FOV adjuster may be configured to switch the effective focal length of the apparatus between a first effective focal length and a second effective focal length.

### TECHNICAL FIELD

This disclosure relates generally to systems and methods for wide area searching. More specifically, this disclosure relates to optical architectures for airborne infrared wide area searching.

### BACKGROUND

Wide area search (WAS), where a large area is continuously monitored by an imaging system, uses airborne sensors to provide persistent coverage of the ground or sea surface. To enable search functions including WAS capabilities, the imaging system can use an infrared detector coupled to optical components, such as lenses and mirrors, to generate a field of view (FOV) of a desired search area. Emerging applications of WAS require spatial resolution over a larger field of regard to generate higher coverage rates.

### SUMMARY

This disclosure provides optical architectures for airborne infrared wide area searching.

In some examples, an apparatus includes a dual head mirror pair configured to receive infrared radiation. The apparatus also includes a field of view (FOV) adjuster optically coupled to the dual head mirror pair and configured to change an effective focal length of the apparatus. The apparatus further includes a focal plane array (FPA) optically coupled to the dual head mirror pair and the FOV switch and configured to receive the infrared radiation.

Any single one or any combination of the following features may be used with the above examples. The dual head mirror pair may include a first dual pair mirror optically coupled to a second dual pair mirror, the first dual pair mirror may be coupled to a first actuator configured for fast steering about a first axis, and the second dual pair mirror may be coupled to a second actuator configured for fast steering about a second axis, the first axis being at a right angle from the second axis. The FOV adjuster may be configured to switch the effective focal length of the apparatus between a first effective focal length and a second effective focal length. The FOV adjuster may include a first portion having a first opacity or reflectivity and a second portion having a second opacity or reflectivity, the first opacity or reflectivity different than the second opacity or reflectivity. The FOV adjuster may further include a plurality of intermittent mirrors optically coupled to the first portion of the FOV adjuster and configured to change the effective focal length to the first effective focal length. The first effective focal length may be greater than the second effective focal length. The FOV adjuster may include a zoom lens.

In other examples, a system includes a first search imager, a second search imager, and a controller. The first search imager includes a first dual head mirror pair configured to receive first infrared radiation, a first field of view (FOV) adjuster optically coupled to the first dual head mirror pair and configured to change an effective focal length of the first search imager, and a first focal plane array (FPA) optically coupled to the first dual head mirror pair and the first FOV adjuster and configured to receive the first infrared radiation from the first FOV adjuster. The second search imager includes a second dual head mirror pair configured to receive second infrared radiation, a second FOV adjuster optically coupled to the second dual head mirror pair and configured to change an effective focal length of the second search imager, and a second FPA optically coupled to the second dual head mirror pair and the second FOV adjuster and configured to receive the second infrared radiation from the second FOV adjuster. A controller is coupled to the first and second search imagers.

Any single one or any combination of the following features may be used with the above examples. Each of the first and second dual head mirror pairs may include a first dual pair mirror optically coupled to a second dual pair mirror, the first dual pair mirror may be coupled to a first actuator configured for fast steering about a first axis, and the second dual pair mirror may be coupled to a second actuator configured for fast steering about a second axis, the first axis being at a right angle from the second axis. The first FOV adjuster may be configured to switch the effective focal length of the first search imager between a first effective focal length and a second effective focal length. The second FOV adjuster may be configured to switch the effective focal length of the second search imager between a third effective focal length and a fourth effective focal length. The first FOV adjuster may include a first portion having a first opacity or reflectivity and a second portion having a second opacity or reflectivity, the first opacity or reflectivity different than the second opacity or reflectivity, and the second FOV adjuster may include a first portion having a third opacity or reflectivity and a second portion having a fourth opacity or reflectivity, the third opacity or reflectivity different than the fourth opacity or reflectivity. The first FOV adjuster may further include a first plurality of intermittent mirrors optically coupled to the first portion of the first FOV adjuster and configured to change the effective focal of the first search imager to the first effective focal length, and the second FOV adjuster may further include a second plurality of intermittent mirrors optically coupled to the first portion of the second FOV adjuster and configured to change the effective focal length of the second search imager to the third effective focal length. The first effective focal length may be greater than the third effective focal length.

In still other examples, a method includes setting an effective focal length of a search imager using a field of view (FOV) adjuster of the search imager, the FOV adjuster optically coupled to a dual head mirror pair of the search imager, receiving infrared radiation from a search area at the search imager, reflecting the infrared radiation using the dual head mirror pair of the search imager, receiving the infrared radiation at a focal plane array (FPA) coupled to the dual head mirror pair, and generating an updated search area by adjusting the effective focal length of the search imager using the FOV adjuster to change one or more dimensions of the search area.

Any single one or any combination of the following features may be used with the above examples. Adjusting the effective focal length of the search imager may include rotating the FOV adjuster during a dead time of the FPA. Rotating the FOV adjuster may include rotating the FOV adjuster to replace a first portion having a first opacity or reflectivity with a second portion having a second opacity or reflectivity, the first opacity or reflectivity different than the second opacity or reflectivity. Adjusting the effective focal length of the search imager may include passing the received infrared radiation through a plurality of intermittent mirrors using the first portion of the FOV adjuster to change the effective focal length of the search imager to a first effective focal length. Adjusting the effective focal length of the search imager may include passing the received infrared radiation through the second portion of the FOV adjuster to change the effective focal length of the search imager to a second effective focal length. The search imager may include a first search imager, and the method may further include receiving second infrared radiation from the search area using a second search imager.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example search environment in accordance with this disclosure;

FIGS. 2A-2B illustrate an example optical architecture of a search imager for an airborne infrared wide area search system in accordance with this disclosure;

FIGS. 3A-3B illustrate example intermittent mirrors of a search imager for an airborne infrared wide area search system in accordance with this disclosure;

FIGS. 4A-4B illustrate example effective focal length changes using an intermittent mirror of an optical system for airborne infrared wide area search in accordance with this disclosure;

FIG. 5 illustrates an example optical architecture of a search imager system for an airborne infrared wide area search system in accordance with this disclosure;

FIG. 6 illustrates an example method for airborne infrared wide area search according to this disclosure; and

FIG. 7 illustrates an example device for airborne infrared wide area search in accordance with this disclosure.

### DETAILED DESCRIPTION

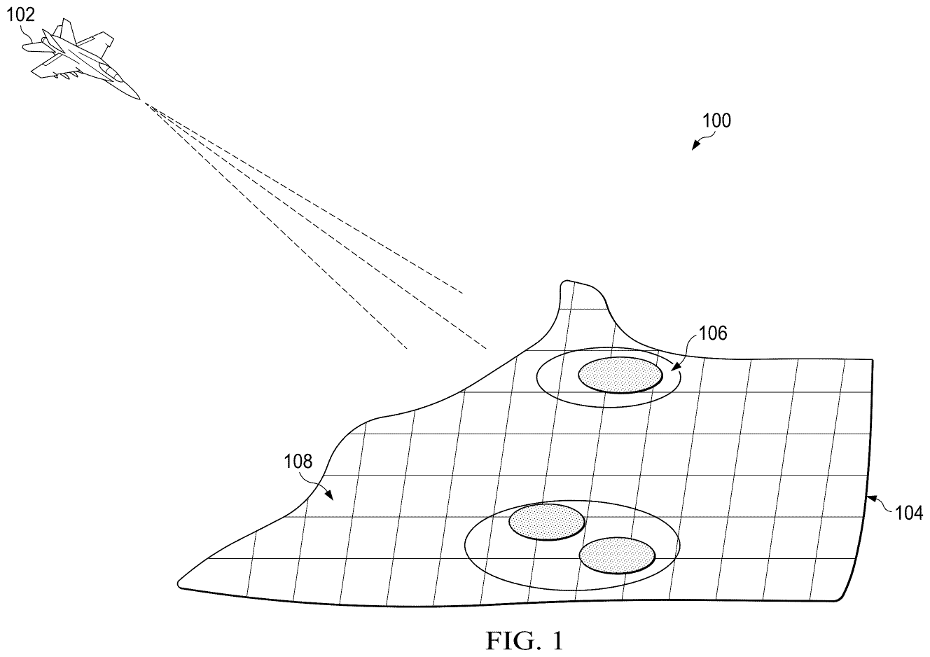

FIGS. 1 through 7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As discussed above, wide area search (WAS), where a large area is continuously monitored by an imaging system, uses airborne sensors to provide persistent coverage of the ground or sea surface. To enable search functions including WAS capabilities, the imaging system can use an infrared detector coupled to optical components, such as lenses and mirrors, to generate a field of view (FOV) of a desired search area. Emerging applications of WAS require spatial resolution over a larger field of regard to generate higher coverage rates.

To enable search functions, a WAS system can use a detector coupled to optical components, such as lenses and mirrors, to generate a field of view (FOV) of a desired search area. However, the FOV is affected, in part, by the effective focal length (EFL) of the optics used in the system. A longer EFL results in a narrower FOV with higher spatial resolution, and a shorter EFL results in a wider FOV that increases the size of the search area. However, imaging systems may operate with only one EFL at a time, resulting in a trade-off between higher spatial resolution and broader search coverage.

This disclosure provides optical architectures for airborne infrared wide area searching. As described in more detail below, a search imager includes a dual head mirror pair configured to receive infrared radiation. The search imager also includes an FOV switch optically coupled to the dual head mirror pair and configured to change an effective focal length of the search imager. The search imager further includes a focal plane array (FPA) optically coupled to the dual head mirror pair and the FOV switch and configured to receive the infrared radiation. In this way, the dual head mirror pair can be used for line-of-sight and image rotation control, and the FOV switch can be used to enable a variable focal length of the search imager to maintain desired ground sample distance over a wide field of regard.

FIG. 1 illustrates an example search environment 100 in accordance with this disclosure. As shown in FIG. 1, an electronic device 102, such as an aerial device, includes a search system to scan a search area 104. For example, the search system of the electronic device 102 may be configured to detect infrared radiation (IR), such as heat, emitted from objects 106 in the search area 104 using one or more IR detectors or IR focal plane arrays (FPAs) as part of a search imager system. The IR received by the IR detectors is processed (such as by using filters, amplifiers, and analog-to-digital converters) to generate one or more digital signals for further processing in at least one processor of the electronic device 102. The processor(s) may use one or more algorithms stored in at least one memory of the electronic device 102 configured for search and/or tracking functions. Further, the search system may aggregate several smaller search regions 108, which may be a portion of the desired search area 104, as the electronic device 102 traverses the search environment 100. The search area 104 may have several search regions 108 having similar cross-track distances (such as a width of each of the search regions 108) and along-track distances (such as a length of each of the search regions 108) to compose the overall cross-track distance and along-track distance of the search area 104.

The search system of the electronic device 102 may be configured for wide area search (WAS) or wide area motion imagery (WAMI). For example, the search system, using the IR detector(s), may continuously monitor a large search area 104 of the search environment 100 using a broad field of view. The search system may include one or more IR detectors or IR FPAs, mirrors, lenses, cooling mechanisms, and signal processing circuitry (such as in a controller of the electronic device 102 coupled to the processor(s)).

As the electronic device 102 moves across the search environment 100, the FOV of the search system shifts along with the orientation of the electronic device 102. For a WAS operation, the search system may use specific scanning patterns that are recalibrated (such as to compensate for vibrations or rotation of the electronic device 102) to maintain continuous coverage of the search area 104. The effective focal length (EFL) of the search system, controlled by the mirrors and lenses, inversely affects the FOV of the system, where a longer EFL narrows the FOV and a shorter EFL widens the FOV. Similarly, a longer EFL results in improved spatial resolution for the IR detector(s), but a longer EFL may require a larger aperture to receive sufficient IR from the search area 104 to produce a result. As such, for IRST functions including WAS or WAMI, the EFL of the search system used by the electronic device 102 affects the size and configuration of the search area 104.

Although FIG. 1 illustrates one example of a search environment 100, various changes may be made to FIG. 1. For example, various components in FIG. 1 may be combined, further subdivided, replicated, omitted, or rearranged and additional components may be added according to particular needs.

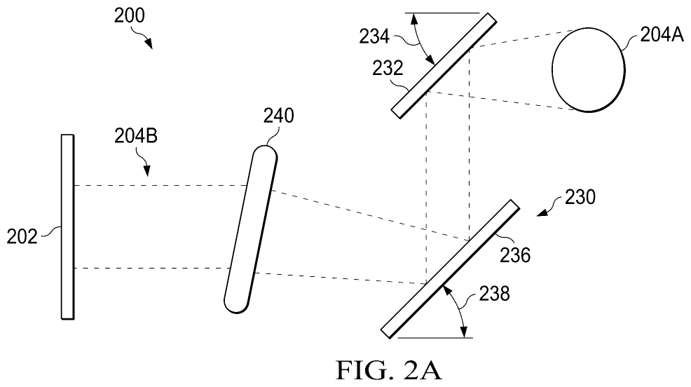

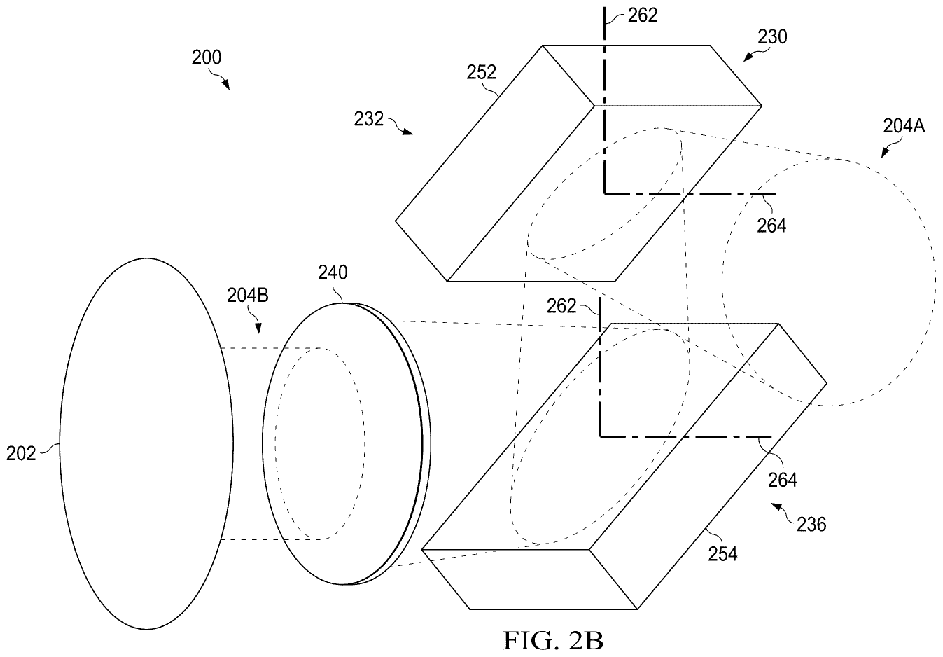

FIGS. 2A-2B illustrate an example optical architecture of a search imager 200 for an airborne infrared wide area search system in accordance with this disclosure. In particular, FIG. 2A illustrates a schematic diagram of the overall architecture of the search imager 200 and FIG. 2B illustrates a dual head mirror pair 230 of the search imager 200.

As shown in FIG. 2A, the search imager 200 includes an IR FPA 202 that captures image frames of a scene. The IR FPA 202 is optically coupled to an FOV adjuster 240 and a dual head mirror pair 230. The dual head mirror pair 230 includes a first dual pair mirror 232 at a first tilt angle 234 and a second dual pair mirror 236 at a second tilt angle 238. The dual head mirror pair 230 can be optically coupled to the FOV adjuster 240, which is configured to switch the field of view of the search imager 200 (such as between a first FOV and a second FOV).

The dual head mirror pair 230 is configured to receive a plurality of IR rays 204A, such as from the search area 104. The search imager 200 may include one or more lenses (such as such one or more concave and/or convex lenses) to collimate or converge the plurality of IR rays 204A to a desired degree. The plurality of IR rays 204A, after passing through the FOV adjuster 240, may become a first plurality of transformed IR rays 204B that can be directed towards the IR FPA 202.

The dual head mirror pair 230 may include image motion compensation (IMC) mechanics for improved LOS control. For example, the dual head mirror pair 230 may include two voice coil motor-actuated or other actuated fast steering mirrors with flexure suspension. In such a configuration, the dual head mirror pair 230 can have rotation axes that cross a center point of each mirror and rotate about these axes based on a reflection matrix of a local mirror frame. For example, as shown in FIG. 2B, the dual head mirror pair 230 may be configured as fast steering mirrors (FSMs). For example, the dual head mirror pair 230 may include a first dual pair mirror 232 optically coupled to a second dual pair mirror 236. The first dual pair mirror 232 may be coupled to a first actuator 252 configured for fast steering about a first axis 262. Similarly, the second dual pair mirror 236 may be coupled to a second actuator 254 configured for fast steering along a second axis 264. The first axis 262 may be at a right angle from the second axis 264. For example, the first dual pair mirror 232 is configured for fast steering about a z-axis where the first actuator 252, coupled to one or more position sensors (not shown), drives movement of the first dual pair mirror 232 based on input received from the one or more position sensors to maintain a desired position of the first dual pair mirror 232 (such as in a desired direction).

The first actuator 252 corrects for residual azimuth motion of the search imager 200. Similarly, the second dual pair mirror 236 is configured for fast steering about an x-axis to reduce residual elevation motion of the search imager 200. Additionally or alternatively, the first dual pair mirror 232 may be further configured for fast steering about the first axis 262. This configuration allows for reduction of roll-induced distortion of the image reflected through the dual head mirror pair 230 to be reduced. The configuration of the head mirrors provides control of line of sight pointing and control, as well as control of image rotation through the interaction of the two mirrors.

Although FIGS. 2A-2B illustrate one example of an optical architecture of a search imager 200 for an airborne infrared wide area search system, various changes may be made to FIGS. 2A-2B. For example, various components in FIGS. 2A-2B may be combined, further subdivided, replicated, omitted, or rearranged and additional components may be added according to particular needs. Also, the FOV adjuster 240 may be replaced by a zoom lens (such as when the FOV adjuster 240 represents a zoom lens rather than an intermittent mirror optically coupled to the dual head mirror pair 230), where the IR FPA 202 captures frames with different but overlapping EFLs so as to maintain ground sample distance (GSD) along the track path of the electronic device 102. In addition, the FOV adjuster 240 may switch between more than two EFLs.

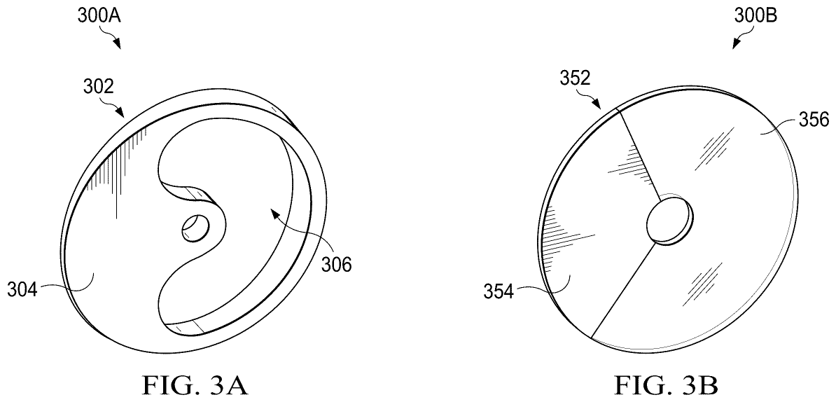

FIGS. 3A-3B illustrate example intermittent mirrors 300A-300B of a search imager for an airborne infrared wide area search system in accordance with this disclosure. As shown in FIG. 3A, the intermittent mirror 300A includes a mirror body 302. Although shown as an annular body, the mirror body 302 may have any other suitable shape. The mirror body 302 includes a first portion 304 and a second portion 306, which are adjacent across a face of the mirror body 302 such that there is no transition portion between the first portion 304 and the second portion 306. The first portion 304 includes a first opacity or reflectivity, and the second portion 306 includes a different second opacity or reflectivity. For example, the first portion 304 may have a reflectivity such that the first portion 304 is capable of reflecting IR rays, while the second portion 306 may have an opacity such that the second portion 306 is capable of transmitting IR rays without causing diffraction through the second portion 306. In some cases, the second portion 306 may form an aperture. As shown in FIG. 3B, the intermittent mirror 300B of FIG. 3B includes a mirror body 352 having a first portion 354 and a second portion 356. The second portion 356 includes an infrared transparent material having the second opacity (such as glass).

Although FIGS. 3A-3B illustrate example intermittent mirrors 300A-300B of a search imager for an airborne infrared wide area search system, various changes may be made to FIGS. 3A-3B. For example, an intermittent mirror may have any other suitable configuration that provides different reflectance and/or transmittance characteristics.

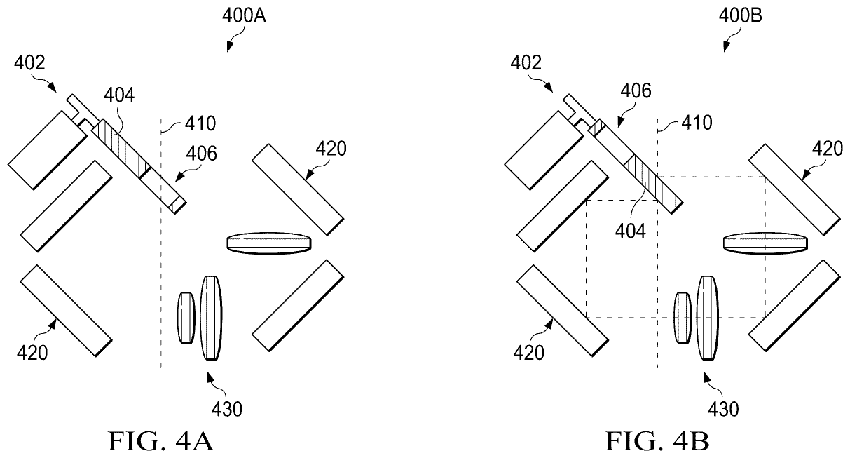

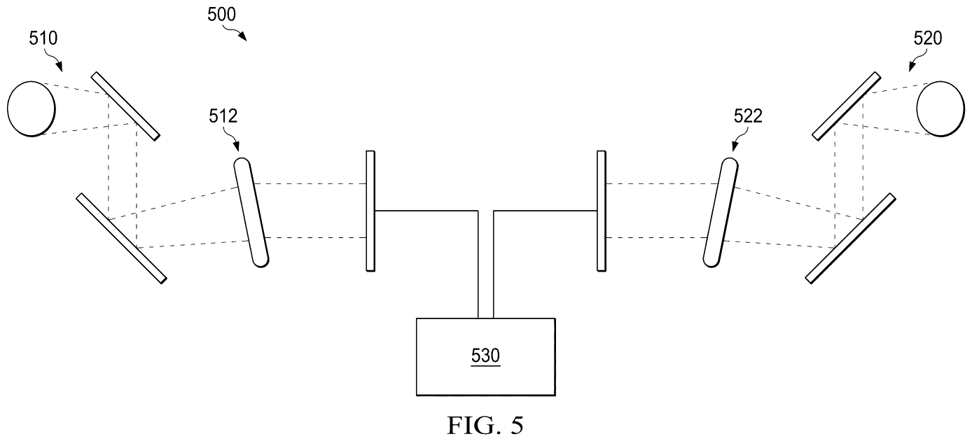

FIGS. 4A-4B illustrate example effective focal length (EFL) changes using an intermittent mirror of an optical system for airborne infrared wide area search in accordance with this disclosure. In particular, FIG. 4A illustrates an example use of an intermittent mirror of an optical system to provide a first EFL, and FIG. 4B illustrates an example use of the intermittent mirror of the optical system to provide a second EFL.

As shown in FIG. 4A, a schematic diagram 400A illustrates an intermittent mirror 402 having a first portion 404 and a second portion 406, which may be the same as or similar to the intermittent mirror 300A of FIG. 3A or the intermittent mirror 300B of FIG. 3B. The intermittent mirror 402 includes an actuator 408 (such as a motor) to drive or actuate the intermittent mirror 402 such that the first portion 404 or the second portion 406 are along an optical path to effectuate a focal length change of the optical system. The schematic diagram 400A further shows a plurality of mirrors 420 and one or more lenses 430 optically coupled to the intermittent mirror 402. The mirrors 420 and the one or more lenses 430 can be configured to direct and transform an IR ray 410. As shown here, the IR ray 410 may pass through the second portion 406 of the intermittent mirror 402 and proceed unobstructed, resulting in a first EFL.

As shown in FIG. 4B, a schematic diagram 400B illustrates the IR ray 410 contacting the first portion 404 of the intermittent mirror 402 (such as a portion of the intermittent mirror 402 that includes a reflective surface). Here, the IR ray 410 may reflect towards the plurality of mirrors 420 and pass through the one or more lenses 430, resulting in collimation, convergence, or both before reflecting out of the intermittent mirror 402. For example, the intermittent mirror 402 may rotate about an axis such that the first portion 404 (rather than the second portion 406) is in the optical path of the IR ray 410, resulting in reflection. The rotation of the intermittent mirror 402 may be controlled by a controller operably coupled to the intermittent mirror 402 and an FPA (such as the IR FPA 202 of the search imager 200). Rotating the intermittent mirror 402 allows for faster FOV switching (such as less settling time) of the IR ray 410, allowing FOV switching within a deadtime of the FPA used in conjunction with the intermittent mirror 402.

Although FIGS. 4A-4B illustrate examples of EFL changes using an intermittent mirror of an optical system for airborne infrared wide area search, various changes may be made to FIGS. 4A-4B. For example, various components in FIGS. 4A-4B may be combined, further subdivided, replicated, omitted, or rearranged and additional components may be added according to particular needs.

FIG. 5 illustrates an example optical architecture of a search imager system 500 for an airborne infrared wide area search system in accordance with this disclosure. As shown in FIG. 5, the search imager system 500 includes a first search imager 510 and a second search imager 520. Each of the first search imager 510 and the second search imager 520 may be configured the same or similar manner as the search imager 200 of FIGS. 2A-2B. Here, the first search imager 510 includes a first FOV adjuster 512, and the second search imager 520 includes a second FOV adjuster 522. Each of the first search imager 510 and the second search imager 520 can be coupled to a controller 530, and the search imagers 510 and 520 can be jointly controlled by the controller 530.

In this example, the first FOV adjuster 512 may switch between a first EFL and a second EFL for the first search imager 510, and the second FOV adjuster 522 may switch between a third EFL and a fourth EFL. To accomplish this, the first FOV adjuster 512 may have a first portion with a first opacity or reflectivity and a second portion with a second opacity or reflectivity. Similarly, the second FOV adjuster 522 may have a first portion with a third opacity or reflectivity and a second portion with a fourth opacity or reflectivity. The first opacity or reflectivity of the first FOV adjuster 512 may be the same as or different from the third opacity or reflectivity of the second FOV adjuster 522. Also, the second opacity or reflectivity of the first FOV adjuster 512 may be the same as or different from the fourth opacity or reflectivity of the second FOV adjuster 522.

The various EFLs supported by the first FOV adjuster 512 and the second FOV adjuster 522 may be different, the same, or overlap. For example, the first EFL and the second EFL of the first search imager 510 may be less than the third EFL and the fourth EFL of the second search imager 520, respectively. In such a configuration, the second search imager 520 may allow for imaging of a region of interest (ROI) further away from the search imager system 500, while the first search imager 510 may allow for imaging of a search region 108 closer to the search imager system 500. If the greater of the first EFL and the second EFL overlaps with the lesser of the third EFL and the fourth EFL, the combined scan patterns may result in a wide area search with large cross-track distance, large along-track distance, or both, allowing for improved searching capabilities of the search imager system 500.

Although FIG. 5 illustrates one example of an optical architecture of a search imager system 500 for an airborne infrared wide area search system, various changes may be made to FIG. 5. For example, various components in FIG. 5 may be combined, further subdivided, replicated, omitted, or rearranged and additional components may be added according to particular needs.

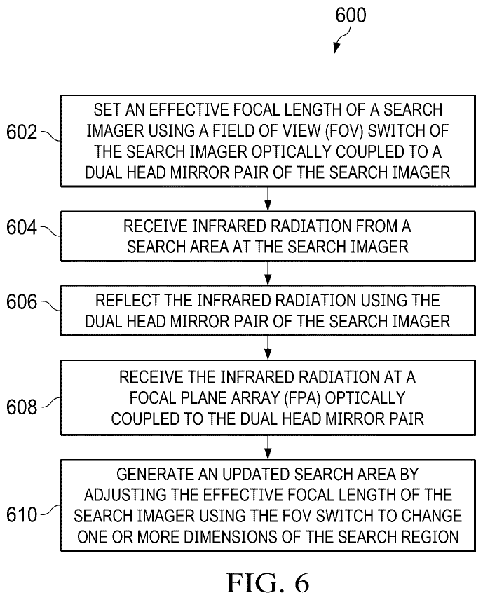

FIG. 6 illustrates an example method 600 for airborne infrared wide area search according to this disclosure. For ease of explanation, the method 600 of FIG. 6 is described as being performed using the search imager 200 of FIGS. 2A-2B. However, the method 600 may be used with any other suitable search imager in any other suitable system.

As shown in FIG. 6, an EFL of a search imager is set using an FOV switch of the search imager at step 602. For example, an FOV adjuster 240 can be optically coupled to a dual head mirror pair 230 of the search imager 200, and the FOV adjuster 240 may be rotated so that either a first portion of the FOV switch or a second portion of the FOV adjuster 240 is in the optical path of the search imager 200. Alternatively, if the FOV switch includes a zoom lens, the EFL of the search imager 200 may be set by adjusting a focal length of the zoom lens.

Infrared radiation from a search area 104 is received using the search imager at step 604. For example, the search imager 200 may receive IR emitted from one or more objects 106 in the search area 104. In configurations where the search imager 200 is a first search imager 510, such as in the search imager system 500, second IR from the search area may be received using a second search imager 520.

The infrared radiation is reflected using the dual head mirror pair of the search imager at step 606. For example, the received IR from the search area 104 may enter the search imager 200 and be reflected by the first dual pair mirror 232 to the second dual pair mirror 236. The first tilt angle 234 and the second tilt angle 238 may be adjusted (such as using the IMC mechanics) to adjust for vibrations, rotation, or other irregularities in the line-of-sight of the search imager 200 to reduce or minimize noise and maintain the dimensional integrity of the search area 104. The infrared radiation is received at an FPA optically coupled to the dual head mirror pair at step 608. For example, after reflection in the dual head mirror pair 230, the received IR may pass through one or more lens sets (such as the first lens set 210, the second lens set 212, and the third lens set 214) and mirrors (such as the first mirror 220 and the second mirror 222) that optically couple the received IR from the dual head mirror pair 230 to the IR FPA 202 at desired optical characteristics (such as a desired GSD).

An updated search area is generated by adjusting the EFL of the search imager using the FOV switch to change one or more dimensions of the search area at step 610. For example, the dual head mirror pair 230 may adjust the FOV to change the cross-track distance, the along-track distance, or both of the search area 104 or of the search regions 108 using the FOV adjuster 240, thereby adjusting the IR received at the IR FPA 202. Adjusting the effective focal length of the search imager 200 using the FOV adjuster 240 may include rotating the FOV adjuster 240 during a dead time of the IR FPA 202. For instance, the FOV adjuster 240 may be rotated to replace the first portion 304 (having a first opacity or reflectivity) with the second portion 306 (having a second opacity or reflectivity). The received IR may pass through a plurality of intermittent mirrors 300A when the first portion 304 of the FOV adjuster 240 is used in order to change the ELF of the search imager 200 to a first effective focal length. The received IR may pass through the second portion 306 of the FOV adjuster 240 to change the effective focal length of the search imager 200 to a second effective focal length.

Although FIG. 6 illustrates one example of a method 600 for airborne infrared wide area search, various changes may be made to FIG. 6. For example, while shown as a series of steps, various steps in FIG. 6 may overlap, occur in parallel, or occur any number of times (including zero times).

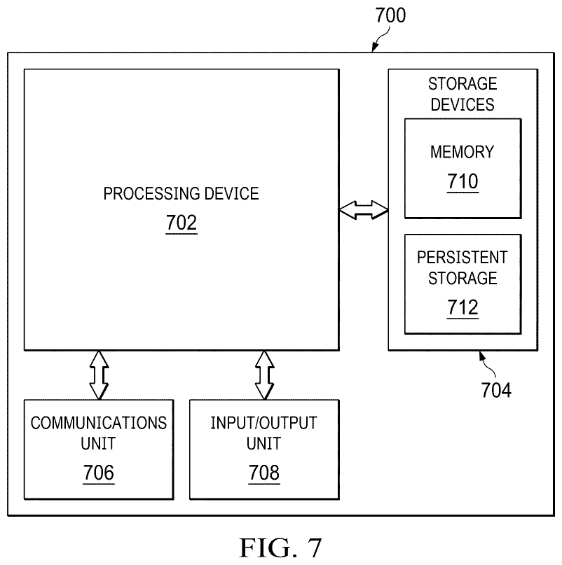

FIG. 7 illustrates an example device 700 for airborne infrared wide area search according to this disclosure. One or more instances of the device 700 (or portions thereof) may, for example, be used to at least partially implement the functionality of any of the search imagers or search imager systems described above. For example, the device 700 may be used to implement a controller (such as the controller 530) used in or with any of the search imagers or search imager systems described above.

As shown in FIG. 7, the device 700 denotes a computing device or system that includes at least one processing device 702, at least one storage device 704, at least one communications unit 706, and at least one input/output (I/O) unit 708. The processing device 702 may execute instructions that can be loaded into a memory 710. The processing device 702 includes any suitable number(s) and type(s) of processors or other devices in any suitable arrangement. Example types of processing devices 702 include one or more microprocessors, microcontrollers, digital signal processors (DSPs), application-specific integrated circuits (ASICs), graphics processing units (GPUs), field-programmable gate arrays (FPGAs), neural processing units (NPUs), or discrete circuitry.

The memory 710 and a persistent storage 712 are examples of storage devices 704, which represent any structure(s) capable of storing and facilitating retrieval of information (such as data, program code, and/or other suitable information on a temporary or permanent basis). The memory 710 may represent a random-access memory or any other suitable volatile or non-volatile storage device(s). The persistent storage 712 may contain one or more components or devices supporting longer-term storage of data, such as a read only memory, hard drive, Flash memory, or optical disc.

The communications unit 706 supports communications with other systems or devices. For example, the communications unit 706 can include a network interface card or a wireless transceiver facilitating communications over a wired or wireless network. The communications unit 706 may support communications through any suitable physical or wireless communication link(s).

The I/O unit 708 allows for input and output of data. For example, the I/O unit 708 may provide a connection for user input through a keyboard, mouse, keypad, touchscreen, or other suitable input device. The I/O unit 708 may also send output to a display or other suitable output device. Note, however, that the I/O unit 708 may be omitted if the device 700 does not require local I/O, such as when the device 700 can be accessed remotely or operated autonomously.

In some embodiments, the instructions executed by the processing device 702 can include instructions that implement portions of the functionality of the search imagers or search imager systems described above. For example, the instructions executed by the processing device 702 can include instructions supporting airborne infrared wide area search, such as instructions for controlling rotations or other operations of intermittent mirrors.

Although FIG. 7 illustrates one example of a device 700 for airborne infrared wide area search, various changes may be made to FIG. 7. For example, computing devices and systems come in a wide variety of configurations, and FIG. 7 does not limit this disclosure to any particular computing device or system.

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine-readable medium excludes wired, wireless, optical, or other communication links that transport transitory electrical or other signals. A non-transitory computer or machine-readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a dual head mirror pair configured to receive infrared radiation;
a field of view (FOV) adjuster optically coupled to the dual head mirror pair and configured to change an effective focal length of the apparatus; and
a focal plane array (FPA) optically coupled to the dual head mirror pair and the FOV adjuster and configured to receive the infrared radiation.

2. The apparatus of claim 1, wherein:
the dual head mirror pair comprises a first dual pair mirror optically coupled to a second dual pair mirror;
the first dual pair mirror is coupled to a first actuator configured for fast steering about a first axis; and
the second dual pair mirror is coupled to a second actuator configured for fast steering about a second axis, the first axis being at a right angle from the second axis.

3. The apparatus of claim 1, wherein the FOV adjuster is configured to switch the effective focal length of the apparatus between a first effective focal length and a second effective focal length.

4. The apparatus of claim 3, wherein the FOV adjuster comprises a first portion having a first opacity or reflectivity and a second portion having a second opacity or reflectivity, the first opacity or reflectivity different than the second opacity or reflectivity.

5. The apparatus of claim 4, wherein the FOV adjuster further comprises a plurality of intermittent mirrors optically coupled to the first portion of the FOV adjuster and configured to change the effective focal length to the first effective focal length.

6. The apparatus of claim 5, wherein the first effective focal length is greater than the second effective focal length.

7. The apparatus of claim 1, wherein the FOV adjuster comprises a zoom lens.

8. A system comprising:
a first search imager comprising:
a first dual head mirror pair configured to receive first infrared radiation;
a first field of view (FOV) adjuster optically coupled to the first dual head mirror pair and configured to change an effective focal length of the first search imager; and
a first focal plane array (FPA) optically coupled to the first dual head mirror pair and the first FOV adjuster and configured to receive the first infrared radiation from the first FOV adjuster;
a second search imager comprising:
a second dual head mirror pair configured to receive second infrared radiation;
a second FOV adjuster optically coupled to the second dual head mirror pair and configured to change an effective focal length of the second search imager; and
a second FPA optically coupled to the second dual head mirror pair and the second FOV adjuster and configured to receive the second infrared radiation from the second FOV adjuster; and
a controller coupled to the first and second search imagers.

9. The system of claim 8, wherein:
each of the first and second dual head mirror pairs comprises a first dual pair mirror optically coupled to a second dual pair mirror;
the first dual pair mirror is coupled to a first actuator configured for fast steering about a first axis; and
the second dual pair mirror is coupled to a second actuator configured for fast steering about a second axis, the first axis being at a right angle from the second axis.

10. The system of claim 8, wherein the first FOV adjuster is configured to switch the effective focal length of the first search imager between a first effective focal length and a second effective focal length.

11. The system of claim 10, wherein the second FOV adjuster is configured to switch the effective focal length of the second search imager between a third effective focal length and a fourth effective focal length.

12. The system of claim 11, wherein:
the first FOV adjuster comprises a first portion having a first opacity or reflectivity and a second portion having a second opacity or reflectivity, the first opacity or reflectivity different than the second opacity or reflectivity; and
the second FOV adjuster comprises a first portion having a third opacity or reflectivity and a second portion having a fourth opacity or reflectivity, the third opacity or reflectivity different than the fourth opacity or reflectivity.

13. The system of claim 12, wherein:
the first FOV adjuster further comprises a first plurality of intermittent mirrors optically coupled to the first portion of the first FOV adjuster and configured to change the effective focal of the first search imager to the first effective focal length; and
the second FOV adjuster further comprises a second plurality of intermittent mirrors optically coupled to the first portion of the second FOV adjuster and configured to change the effective focal length of the second search imager to the third effective focal length.

14. The system of claim 13, wherein the first effective focal length is greater than the third effective focal length.

15. A method comprising:
setting an effective focal length of a search imager using a field of view (FOV) adjuster of the search imager, the FOV adjuster optically coupled to a dual head mirror pair of the search imager;
receiving infrared radiation from a search area at the search imager;
reflecting the infrared radiation using the dual head mirror pair of the search imager;
receiving the infrared radiation at a focal plane array (FPA) coupled to the dual head mirror pair; and
generating an updated search area by adjusting the effective focal length of the search imager using the FOV adjuster to change one or more dimensions of the search area.

16. The method of claim 15, wherein adjusting the effective focal length of the search imager comprises rotating the FOV adjuster during a dead time of the FPA.

17. The method of claim 16, wherein rotating the FOV adjuster comprises rotating the FOV adjuster to replace a first portion having a first opacity or reflectivity with a second portion having a second opacity or reflectivity, the first opacity or reflectivity different than the second opacity or reflectivity.

18. The method of claim 17, wherein adjusting the effective focal length of the search imager comprises passing the received infrared radiation through a plurality of intermittent mirrors using the first portion of the FOV adjuster to change the effective focal length of the search imager to a first effective focal length.

19. The method of claim 18, wherein adjusting the effective focal length of the search imager comprises passing the received infrared radiation through the second portion of the FOV adjuster to change the effective focal length of the search imager to a second effective focal length.

20. The method of claim 15, wherein:
the search imager comprises a first search imager; and
the method further comprises receiving second infrared radiation from the search area using a second search imager.
